(19) United States
(12) Patent Application Publication
(10) Pub. No.: US 2009/0007194 A1
(43) Pub. Date: Jan. 1, 2009

(54) REMOTE RECOVERY OF IN-FLIGHT ENTERTAINMENT VIDEO SEAT BACK DISPLAY AUDIO

(75) Inventors: Kenneth A. Brady, JR., Trabuco Canyon, CA (US); Gary E. Vanyek, Laguna Niguel, CA (US); V. Ian McClelland, Irvine, CA (US); Arnaud Heydler, Newport Beach, CA (US); Harmon F. Law, Irvine, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 12/111,313

(22) Filed: Apr. 29, 2008

Related U.S. Application Data
(60) Provisional application No. 60/924,103, filed on Apr. 30, 2007.

(51) Int. Cl. H04N 7/18

(52) U.S. Cl. 725/77

(57) ABSTRACT

A system and method permit remote recovery of audio from audiovisual or multimedia content for a video display unit. Audio is recovered from the audiovisual content sent to a first network address and is packetized for transmission over a network that may utilized an existing wiring infrastructure that provides audio and video-on-demand content to a second network address. The audio packets are reassembled by hardware associated with the second network address and analog audio created from the audio packets is provided at an output to an audio device.

### CROSS REFERENCE TO RELATED APPLICATIONS

The present application claims the benefit of U.S. Provisional Application No. 60/924,103 filed Apr. 30, 2007, and herein incorporated by reference.

### BACKGROUND OF THE INVENTION

1. Field of the Invention

The present invention relates to a system and method for providing in-flight entertainment (IFE) throughout a cabin of a vehicle, such as an aircraft. The present invention particularly relates to IFE systems and the wiring in each seat group to implement the video audio connections from the seat-back video display unit (SVDU) to the passenger headsets, which are typically wired from a seat electronics box (SEB), which is typically located under the seat.

2. Description of Related Art

A disadvantage of related IFE systems is that left and right stereo audio signals from the SVDU are typically routed back to the underseat SEB, where audio multiplexers and the headset audio amplifiers are located. Three or four wires are typically needed to bring the stereo audio from each display back to the SEB. Thus, in a grouping of four seats, this means that up to 16 wires must be bundled and routed through the forward seat group, down to the floor, through the raceway, and into the next seat group. These related IFE systems suffer from a number of disadvantages including the added weight and cost of the wiring and disconnects, the additional installation engineering effort to route the wires within the seat group, and the added bulk of the wiring that must be routed to the seat group behind, through available raceways of limited size.

As an alternative approach, an audio jack may be co-located with the SVDU. However, this alternative approach also suffers from a number of disadvantages, including passenger annoyance when they feel the motion in the seat back from the passenger behind them inserting and removing a plug into the audio headset jack, as well as headset cords that may potentially impede passenger ingress and egress between the seat group and the aisle. Also, SVDUs do not typically incorporate an IFE system decoder for aircraft public address (PA) audio content. Consequently, it can be difficult to provide to the passenger headset PA audio that is synchronized with the overhead PA speakers in the passenger cabin.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain features of the invention.

FIGS. 1A and 1B are diagrams illustrating examples of seating layouts for commercial aircraft in which an embodiment of the present invention may be employed;

FIG. 2 illustrates an example of an in-seat video player arrangement for the commercial aircraft as shown in FIGS. 1A and 1B;

FIG. 3 is a conceptual block diagram illustrating an example of an IFE system employed in an aircraft as shown in FIGS. 1A and 1B and which may employ an embodiment of the present invention;

FIG. 4 is a conceptual block diagram illustrating the overall data flow in an embodiment of an IFE system according to the present invention;

FIG. 5 is a conceptual block diagram illustrating a SVDU functional block according to an embodiment of the present invention;

FIG. 6 is a pictorial schematic diagram illustrating the layout and interconnections of components used in an embodiment of the present invention;

FIG. 7 is a block diagram of an embodiment of the invention illustrating the splitting and recombining of the audio data; and

FIG. 8 is a flowchart illustrating the procedural steps according to an embodiment of the invention.

### DETAILED DESCRIPTION OF EMBODIMENTS

Embodiments of the present invention provide a system and method for presenting video and associated audio to multiple presentation devices, such as multiple video players and multiple audio headsets in an IFE system in a vehicle. This environment is typically an airplane, train, bus, boat, ship, or other multi-passenger vehicle where there are multiple overhead video monitors being viewed by multiple passengers who listen to the audio associated to the overhead video program through a headset plugged into an audio jack local to the passenger's seat. Alternately, or additionally, such an environment may further comprise individual passenger video monitors typically located in the back of a seat or in an area directly in front of the passenger for an individual viewing experience, and a corresponding audio output that is provided typically from a location on the passenger's own seat.

The IFE system is capable of providing audio and/or visual content to a large number of locations in the vehicle cabin, while at the same time minimizing the amount of cabling that is required for providing such a capability. The concept of “remote audio” deals with the issue of passenger headset audio jack location, particularly when it is located separately from the video display for combined audiovisual media content.

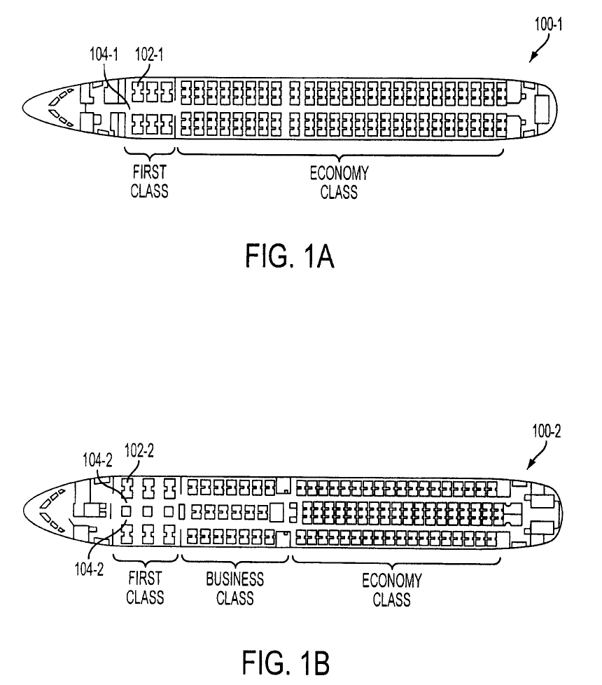

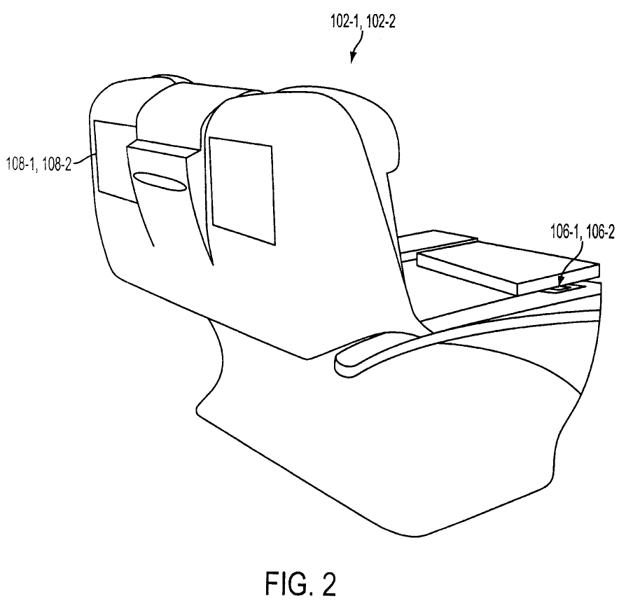

FIGS. 1A and 1B illustrate examples of typical seating arrangements for two different aircraft 100-1 and 100-2. As shown, the environment of an IFE system for the aircraft 100-1 or 100-2 includes a densely packed population of passenger seats 102-1 or 102-2 (hereinafter generically referred to as a seat or seats 102) organized into rows and columns. Seats are typically organized into groups of from 2 to 4 side-by-side seats, and seat groups are placed into long rows running between the front and back of the aircraft. Short distance aircraft 100-1 typically have two rows of seat groups with the center aisle 104-1 for access. Longer distance aircraft 100-2 typically have three rows of seat groups with two aisles 104-2 for access. As shown in FIG. 2, each passenger seat 102 is provided with a headset jack 106-1 or 106-2 (hereinafter generically referred to as headset jack or jacks 106) into which an audio headset can be plugged.

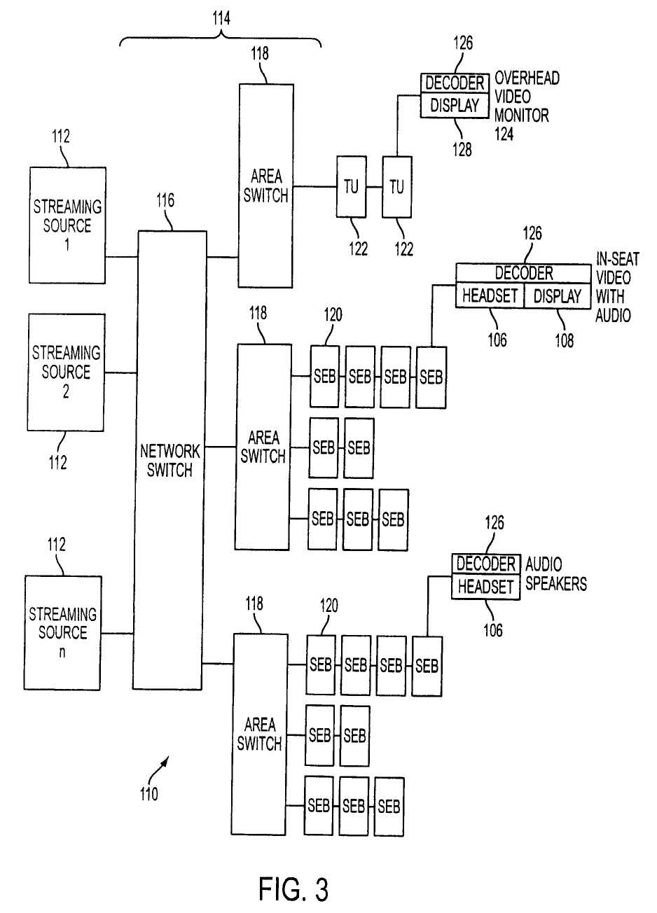

Entertainment audio is typically presented to each passenger over their respective headset. Entertainment video is typically presented to passengers in two different ways, either via overhead video monitor 124 (see FIG. 3) or via an in-seat video player 108-1 or 108-2 (see FIG. 2). In the overhead video arrangement, an aircraft 100-1 or 100-2 is fitted with a number of overhead video monitors 124 to which a video program can be supplied. Overhead video systems have evolved from those which provided a single video projector in each class of the aircraft cabin to current systems which provide a large number of individual monitors hung from the ceiling or baggage bins. In current systems, each passenger can choose to watch the overhead monitor most convenient for their personal viewing.

In the in-seat video player arrangement, the aircraft 100-1 or 100-2 is equipped with individual video players 108-1 or 108-2 (hereinafter generically referred to as a video player or players 108) for each passenger seat 102, as shown in FIG. 2, which provides each passenger with an individualized entertainment experience. It is common to combine both types of video presentation into an aircraft, and it is also common to differentiate service to different passenger classes (e.g., in-seat video for first and business classes, and overhead video in economy class). In either case, the overhead video monitors and in-seat video players 108 communicate with an IFE system 110 as shown in FIG. 3.

An example of the physical architecture of the digital network in a typical IFE system 110 is further illustrated in FIG. 3. The basic components are a set of head-end streaming sources 112, a distribution network 114 that can include one or more network switches 116 and a plurality of area switches 118, and columns of seat components such as SEBs 120 that comprise, among other things, circuitry for handling network communications directed to elements associated with respective seats, and tapping units (TU) 122. The streaming sources 112 may be digital servers (e.g., preloaded with MPEG digital content or other form of multimedia/audiovisual content) or may be real-time encoders capable of converting input video and audio into MPEG or other form of data. The network switch 116 can be, for example, a layer 2 or layer 3 Ethernet switch, and is configured to connect any of the streaming sources 112 to any component of the IFE system 110 of the aircraft. An area switch 118 is provided in each area of the aircraft 100-1 or 100-2 to connect the network switch 116 to multiple columns of seats. In this example, each area switch 118 connects to three seat columns, but the number of seat columns to which an area switch 118 connects can vary as desired.

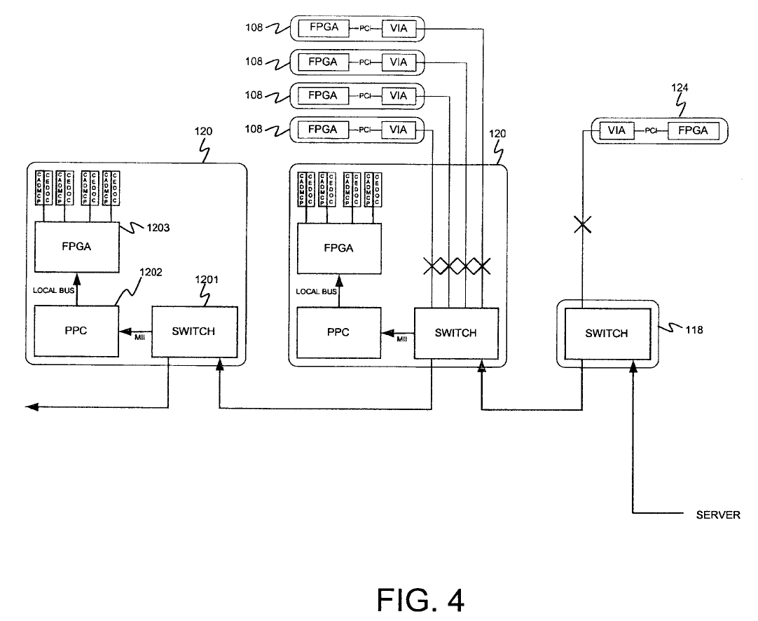

Each seat group as discussed above is fitted with an SEB 120, and the components at the seats 102, such as the video players 108 and headset jacks 106, are wired from an area switch 118 through a number of SEBs 120 arranged in a seat column. As can be appreciated by one skilled in the art, an SEB 120 extracts data packets intended for locally attached players (decoders) and passes other packets through to the next SEB 120 in the seat column as required (see also FIG. 4).

As further shown in FIG. 3, each overhead monitor 124 typically includes or is associated with a decoder 126 and a display 128. The overhead monitors 124 are, in this exemplary arrangement, connected to the IFE system 110 through a set of TU 122 that perform the same or similar functions as the SEBs 120. As also shown, each headset jack 106, and in-seat video player 108, includes or is associated with a decoder 126 that is connected to an SEB 120 as discussed above.

It should be noted that although various embodiments discussed herein include the SEB 120 as a functional component of the system, such a separate dedicated piece of hardware that is used to communicate with seat groups is not essential for the communications involved in the present invention. Each seat may comprise a dedicated address, and communications could be directed to an individual seat, where each seat comprises the necessary decoding and processing hardware and software to achieve the features of the invention.

Many IFE systems 110 have multiple video programs stored on a streaming source 112. When playback is desired, a video player (e.g., video player 108 or overhead monitor 124) obtains the material from the streaming source 112 and decodes the compressed content into a presentable form. If the material is to be presented on overhead monitors 124 or in a video announcement that is to be simultaneously viewed by all passengers, the material typically can be decoded by a single player and distributed to all monitors using an analog distribution technique, e.g., through RF modulation or baseband distribution technologies. If the material is to be presented to a passenger on an individual basis (e.g., Video on Demand) then the passenger has a dedicated player (e.g., a video monitor 108), which can obtain a compressed digital program and decode it specifically for the passenger.

To support a broadcast program, a streaming source 112 would typically transmit a digital stream throughout the digital network of the IFE system 110 using a network protocol appropriate for a one-to-many relationship. As can be appreciated by one skilled in the art, typically the TCP/IP protocol is used for one-to-one communications, although any other form of point-to-point networking could be utilized, and the invention is not to be limited to any particular protocol presented herein by way of example. Also, a one-to-many network protocol, commonly referred to as a “multi-cast,” can be combined with a fixed rate streaming protocol such as a Real-Time Protocol (RTP).

As can further be appreciated by one skilled in the art, multicast on an IP network typically assigns each multicast program a specific multicast IP address. The streaming source 112 can then transmit the program onto the network (e.g., using RTP) with, for example, a broadcast layer 2 address and the assigned multicast layer 3 address. The network of the IFE system 110 can make this stream available to all network devices, such as a video player 108 and overhead monitors 124. A player (e.g., video player 108) can present this program by “subscribing” to the program using the Internet Group Management Protocol (IGMP) protocol specifying the desired multicast IP address. This process permits the streaming source to transmit a single data stream and have it received by all desired players on the network.

The example of the data network architecture described above with regard to FIG. 3 enables a streaming source 112 to produce a single packetized video/audio stream which is available to all desired video players 108 and overhead monitors 124 in the aircraft 100-1 or 100-2. This arrangement allows for a personal, in-seat presentation of a common source program to requesting passengers.

This design further permits the use of multiple streaming data sources 1-n 112 to be utilized on the network without requiring architecture design changes, with the exception that subscriber lists are created for each of the streaming data sources 112.

According to embodiments of the present invention, recovered audio from the multimedia or audiovisual information is packetized for transmission over the existing network infrastructure of the vehicle and directed to remotely located hardware, where the audio is combined/de-packetized, processed, and provided to an audio output device that is separated from the device used to provide the video to the user without requiring dedicated wiring from the video display unit to the audio output device.

In a preferred embodiment, the multimedia information is encoded in MPEG format. Audio is recovered from the MPEG data by a decoder located in the SVDU, and the audio is re-sampled and packetized for transmission over the cabin Ethernet network to its assigned destination. Preferably, this destination is an SEB, although the destination could also be any other suitable device, such as another SVDU. The Ethernet packet uses the existing wiring infrastructure that provides audio and video on demand (AVoD) content to each seat group, thus, as noted above, permitting elimination of dedicated audio wiring from the SVDUs.

According to an embodiment of the present invention, each SVDU transmits its audio packets over Ethernet to the SEB or other device where they are routed to a reprogrammed field programmable gate array (FPGA), that may provide an asynchronous RS485 (or EIA-485) multipoint serial connection transport mechanism to transmit the data over a twisted wire pair to the SEB in the seat group immediately behind. The FPGA of the receiving SEB then acquires the RS485 data and reconstitutes the TCP/IP packet, including the address of the “destination” SVDU. The packet is sent to the SEB switch, and then on to the appropriate SVDU.

According to an embodiment of the present invention, recovered SVDU audio (e.g., from an MPEG decoder or game processor) in digital, uncompressed 16 bit, 48 Khz sampled format (a.k.a., PCM) may be packetized in a TCP/IP format, and assigned an address (from the database) to a “destination” SVDU. Although packetizing the uncompressed data is advantageous, since it does not require additional hardware or software to perform a recompression and decompression, the invention is to be construed broadly enough to encompass such a possible recompression prior to transmission over the network, and decompression of the audio data upon receipt of the audio data.

Thus, according to embodiments of the present invention, standard Internet Protocol (IP) addressing techniques may be used to ensure that the audio packet arrives at the correct destination. A dedicated component to combine the audio packets 234 in the SEB 120 or other device may be utilized to receive the packet and convert it to an analog format and direct it to the appropriate headset 106A. Addressing information contained within the packet could be used to specify an address of the actual seat for which the audio is directed. According to an embodiment of the present invention, PCM audio may be extracted from the transport packet and routed through an internal multiplexer (MUX) to an audio D/A converter.

In a further embodiment, the component to combine the audio packets 234 may be located with the seat itself, and the data packets could be routed through the SEB 120 to the appropriate seat address, where the packets are reassembled and the audio data extracted and presented to the user.

Referring to FIG. 4, content is provided from a server, e.g., the streaming source 112, through area switch 118 to each SEB 120. According to preferred embodiments of the invention, separate wire sets from each SVDU 108 and from the overhead monitor 124 to the audio output are no longer required. Each SEB 120 (two are shown) may include a switch 1201, a PPC 1202, and a FPGA 1203.

As noted above, the SVDU may incorporate circuitry to permit re-encoding of uncompressed recovered audio data into a format suitable for transmission and recovery at the SEB 120 or other device at the destination address. The implementation may be such that it does not impose restrictions on the encoding characteristics of the audio associated with the video.

The encoding, formatting, transmission and recovery of the audio should preferably be of sufficiently low latency (approximately <30-50 ms) that there are no visible “lip synchronization” effects between the audio at the headset and the displayed video image. The protocols described above are sufficient to permit such low latency transmissions if proper known network structuring techniques are utilized and if the network does not become saturated with traffic. The low latency is further achieved when the packetized audio data is not recompressed and decompressed, since these steps consume additional time. Moreover, the encoding, formatting, transmission and recovery of the audio may be accomplished with a minimum of additional heat, weight, and cost to the system elements.

The method of assigning a destination address to the Ethernet audio packet may be flexible to allow different installations and interconnections.

The buffer size of the decoder at the SEB may be sufficient, for example, to cope with expected jitter in packet delivery times, but may be small enough to avoid excessive latency that, for example, could impair audio/video synchronization.

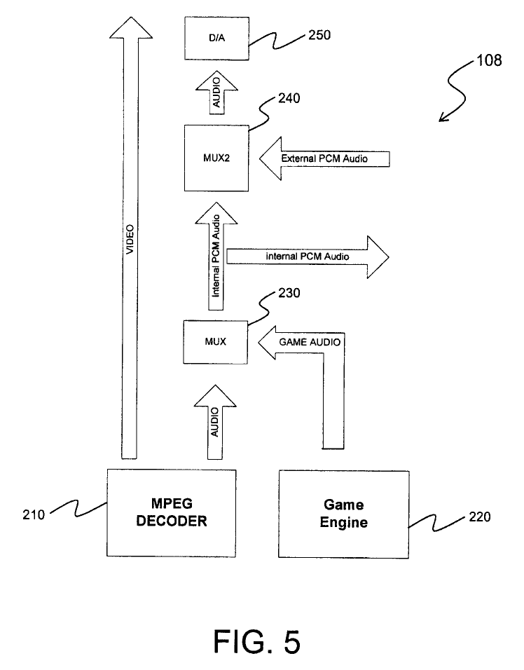

FIG. 5 shows a detail view of an SVDU functional block 108. A first multiplexer MUX 230 may be used if audio from either the MPEG decoder 210 in a game engine 220 is available. A second multiplexer MUX2 240 may be required because in some cases (e.g., at the front row of seats), and the analog audio will be brought out of the SVDU 108 directly and then supplied to an audio D/A converter 250, which is connected to an audio jack and headphones.

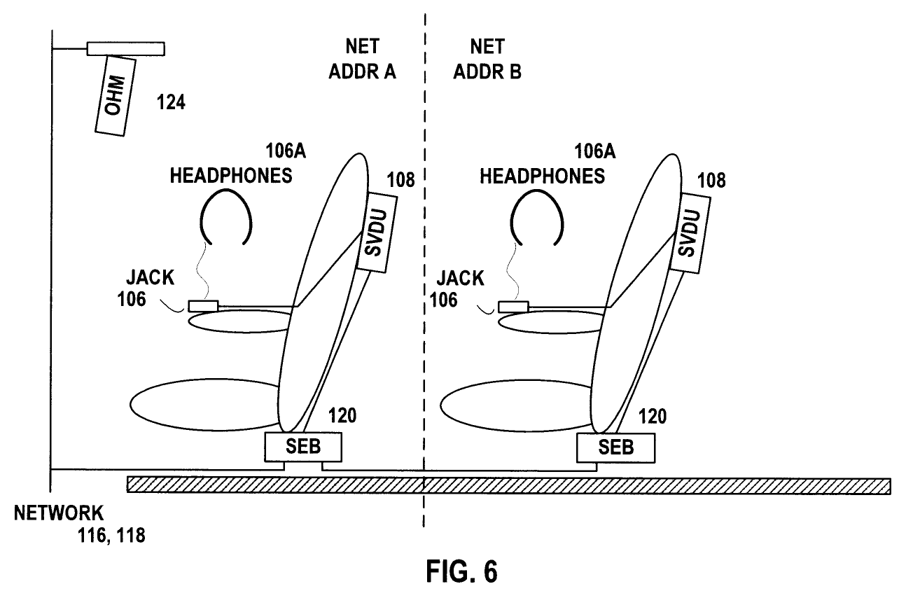

FIG. 6 provides a hybrid pictorial and schematic layout of an embodiment of the inventive system. In FIG. 6, multimedia or audio-visual data is directed over the network 116, 118 to an SVDU 108 at Network Address A through the SEB 120. The audio information is split from the audio-visual data, packetized, and sent to the seat behind it at Network Address B over the network 116, 118, through the SEB 120. Hardware associated with Network Address B then reassembles the audio data packet, performs a D/A conversion and processes the signal, and finally presents the analog audio signal to headphones 106A via the headphone jack 106.

The audio data associated with multimedia or audio-visual data sent to an overhead monitor (OHM) 124 can similarly be packetized and sent to one or more addresses associated with audio processing for those seats that are related to a particular OHM 124. A user of a particular seat associated with an address may still wish to subscribe to a particular audio content associated with the OHM 124, such as when (as noted above) a different language is desired by the user. Thus, the system permits a user to subscribe to audio and video content separately (for maximum flexibility), although the system could also be designed to permit a subscription only to audio and video that are tied together (less complexity).

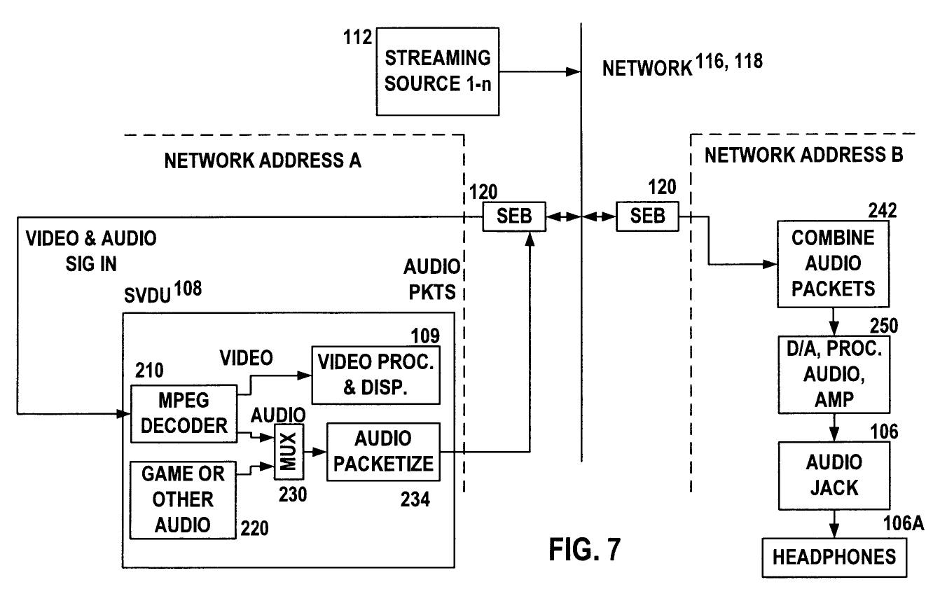

FIG. 7 is a block diagram providing a further illustration of the signal and data flow over the network 116, 118. As can be seen, the streaming source 112 provides multimedia or audio-visual data over the network to various subscribers. By way of the example illustrated in FIG. 7, a user in the seat associated with Network Address B subscribes to a particular audio-visual media. Software associated with the IFE knows that the SVDU 108 associated with the user in the seat associated with Network Address B is located at Network Address A, and therefore directs the audio-visual data to the Network Address A. The combined audio-visual data is routed through the SEB 120 associated with Network Address A, where it is decoded by a decoder 210, such as an MPEG decoder for MPEG data. It should be noted that although the decoder 210, splitting, packetizing 234, and other functions are illustrated as being located in the SVDU 108, there is no requirement that the components associated with such functionality be physically located within the SVDU 108.

As illustrated, the decoder 210 splits the audio and video apart and directs the video to a video processor and display 109 associated with Network Address A. The audio data is sent to a component 234 that packetizes the audio for subsequent transmission over the network to Network Address B. As noted above, this information is preferably not compressed prior to transmission, but may be compressed if known engineering principles suggest that it would be advantageous to do so. As illustrated, a multiplexer 230 may be provided so that game or other audio data 220 can be properly packetized and transmitted over the network as well.

The packetized audio data may then be accessed by the SEB 120 at Network Address B, where a component 242 exists for combining the audio packets together. The combined audio data may be processed 250 and converted to analog from digital (the processing may occur via either or both of analog and digital processing) and then presented to the audio jack 106 for subsequent output to the headphones 106A.

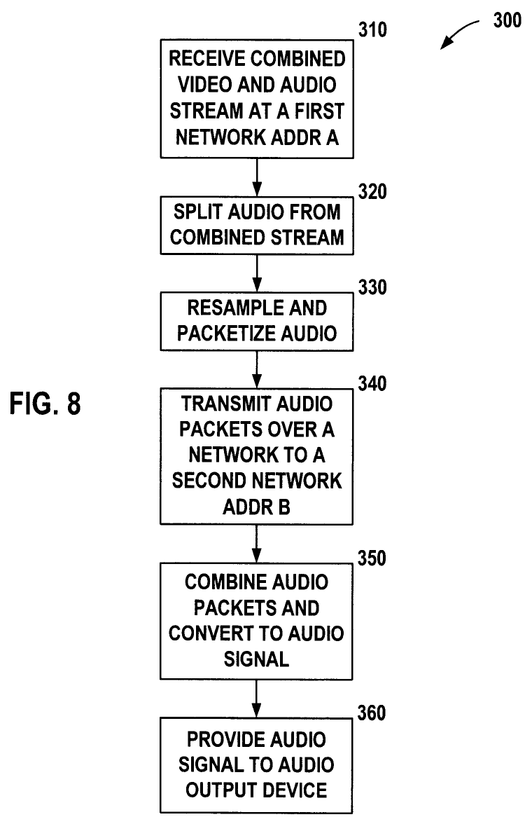

FIG. 8 is a basic flowchart that illustrates the steps defined above, namely, that a combined audio and video stream is received by hardware at a first network address 310, and the audio is split 320 from this combined stream. The audio, if it is in analog form, is re-sampled and packetized 330 for subsequent transmission over the network to a second network address 340. Components at the second network address combine the audio packets, process them, and produce an analog audio signal 350, which is then presented to an audio output device 360.

Embodiments of the present invention may provide a number of features and advantages, including locating the audio jack in the seat arm, thereby reducing physical contact/disturbance of the seatback from the passenger seated in the row behind. Moreover, this location is compatible with some manufacturing preferences and is consistent with possibly emerging seat wiring standards that could prohibit baseband audio feedback wiring from the seatback SVDU to the seat arm. According to embodiments of the present invention, it is also possible to maintain audio/video synchronization during both normal play and “trick” modes (e.g., search forward/reverse), and to also support the aircraft PA latency requirement, e.g., 35 milliseconds maximum between headset PA audio and that from the overhead speakers.

In sum, various embodiments of the present invention advantageously provide audio that is recovered from the MPEG decoder in the SVDU, and is re-sampled and packetized for transmission over the cabin Ethernet network to its assigned destination SEB. The Ethernet packet uses the existing wiring infrastructure that provides AVoD content to each seat group, thus permitting deletion of dedicated audio wiring from the seat back displays. Additionally, standard IP addressing techniques ensure that the audio packet arrives at the correct destination, and a dedicated decoder in the SEB receives the packet and converts it to analog format for the headset.

Additionally, the present invention may also be used to distribute audio content associated with overhead video programs. In that case, the audio packets from an overhead monitor may be assembled as a multicast stream, to permit access by any interested passengers. The scheme may be expanded to permit multicast streams from different overhead monitors, for example, each one playing a different language track. In this way, a passenger would be able to select the language track desired. Thus, the present invention may also provide synchronized multi-language video and audio to in-seat headsets from overhead monitors.

The system or systems may be implemented on any general purpose computer or computers and the components may be implemented as dedicated applications or in client-server architectures, including a web-based architecture. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions executable on the processor on media such as tape, CD-ROM, etc., where this media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method of remotely recovering audio from multimedia or audiovisual content for a video display unit, comprising:
receiving, via a network, at a first network address, audiovisual content directed toward a device at the first network address;
splitting audio information from the audiovisual content;
packetizing the split audio information;
transmitting, over the network, the packetized audio information to device at a second network address;
producing an analog audio stream from the packetized audio information; and
providing the analog audio stream to an audio output device.

2. The method according to claim 1, further comprising providing the audiovisual content by a streaming source to the network.

3. The method according to claim 2, wherein the audiovisual content is video-on-demand.

4. The method according to claim 1, further comprising associating the second network address with the first network address in a one-to-one relationship.

5. The method according to claim 4, further comprising displaying visual information of the audiovisual content to a user from the audiovisual content on the video display unit associated with the first network address, and wherein the analog audio stream is provided to the user from hardware associated with the second network address.

6. The method according to claim 5, wherein the audiovisual content is routed to the first network address through a first seat electronics box, and the packetized audio stream is routed to the second network address through a second seat electronics box.

7. The method according to claim 6, wherein the second seat electronics box combines the packetized audio information.

8. The method according to claim 1, wherein the transmitting comprises routing over a transport mechanism to a seat electronic box that corresponds to the video display unit.

9. The method according to claim 8, wherein the transport mechanism comprises a twisted wire pair.

10. The method according to claim 9, wherein the transport mechanism utilizes an EIA-485 or RS-485 multipoint serial connection transport mechanism.

11. The method according to claim 1, further comprising:
subscribing to one of a plurality of streaming sources by a user;
associated at least one of the first network address and the second network address with the user; and
maintaining a subscriber list for subscribers to each of the plurality of streaming sources.

12. The method according to claim 11, further comprising utilizing Internet Group Management Protocol (IGMP) to specify multicast IP address.

13. The method according to claim 1, wherein the packetized audio information is uncompressed.

14. The method according to claim 13, wherein the packetized audio information is in a 16-bit, 48 kHz format.

15. The method according to claim 1, wherein the network is an Ethernet-based network.

16. The method according to claim 1, wherein the network addresses are Internet Protocol (IP) addresses.

17. The method according to claim 1, wherein the network comprises one or more switches.

18. The method according to claim 1, wherein the multimedia or audiovisual content is in MPEG format.

19. The method according to claim 18, wherein the splitting is performed with an MPEG decoder.

20. The method according to claim 1, wherein the latency between displayed video of the audiovisual content and provided audio of the audiovisual content is <35 ms.

21. The method according to claim 1, further comprising transmitting, over the network, the packetized audio information to a device at least a third network address.

22. The method according to claim 21, wherein the transmission to the addresses comprises utilizing a multicast address.

23. The method according to claim 22, further comprising utilizing Real Time Protocol (RTP) for the transmitting.

24. The method according to claim 23, further comprising utilizing a broadcast layer 2 address and an assigned multicast layer 3 address.

25. The method according to claim 1, further comprising providing the audiovisual content by a streaming source to the network from at least one of digital servers or real-time encoders.

26. A system for remotely recovering audio from multimedia or audiovisual content for a video display unit, comprising:
a network;
a source for the audiovisual content connected to the network;
hardware connected to the network having a first network address that receives the audiovisual content from the source;
a component associated with the first network address hardware that splits audio information from the audiovisual content, packetizes the split audio information and transmits the packetized audio information over the network;
hardware connected to the network having a second network address that receives the packetized audio information over the network, and produces an analog audio stream from the packetized audio information; and
an output device that provides audio output from the analog audio stream.
